(19) United States
(12) Patent Application Publication
(10) Pub. No.: US 2006/0240719 A1
(43) Pub. Date: Oct. 26, 2006

(54) Method of adjusting image parameter and scanning apparatus

(76) Inventors: Shing-Chia Chen, Ciaotou Township (TW); Sei-For Hsu, Jhubei City (TW)

Correspondence Address: RABIN & Berdo, PC, 1101 14TH STREET, NW, SUITE 500, WASHINGTON, DC, 20005, US

(21) Appl. No.: 11/406,366

(22) Filed: Apr. 19, 2006

(30) Foreign Application Priority Data
Apr. 20, 2005 (TW) 94112636

(51) Int. Cl. H01R 13/73

(52) U.S. Cl. 439/894

(57) ABSTRACT

A method of adjusting an image parameter and a scanning apparatus are provided. The method includes the steps of: scanning a standard picture and moving the standard picture by an actual distance; generating a pulse signal corresponding to the actual distance; getting a standard distance corresponding to the pulse signal; and comparing the actual distance with the standard distance and adjusting a default pulse frequency. When the actual distance is shorter than the standard distance, the default pulse frequency is increased. When the actual distance is longer than the standard distance, the default pulse frequency is decreased.

This application claims the benefit of Taiwan application Serial No. 94112636, filed Apr. 20, 2005, the subject matter of which is incorporated herein by reference.

### BACKGROUND OF THE INVENTION

1. Field of the Invention

The invention relates in general to a method of adjusting an image parameter and a scanning apparatus using this method, and more particularly to a method and an apparatus of adjusting a mechanical parameter to compensate for an image parameter.

1. Description of the Related Art

In scanning apparatuses, such as a scanner, a multi-function printer, and the like, an adjusting operation (calibration) has to be performed before each scanning process in order to ensure the scanned quality. For example, the gain and the offset of the analog front end (AFE) have to be adjusted, and the photo response non-uniformity (PRNU) and the dark signal non-uniformity (DSNU) of the charge coupled device (CCD) have to be compensated.

However, the adjusting procedure mentioned hereinabove only can adjust the factor of influencing the image quality in the aspect of the deviations of the electric elements of the scanning system. However, no adjusting procedure has been proposed to adjust the variation in the transmission mechanism after a long term of usage, wherein the variation in the transmission mechanism may influence the precision of a leading edge of the document, the precision of the image magnification in the scanning direction, and the precision of the color registration.

In general, the image of the to-be-scanned picture is acquired by a chassis of a scanning apparatus moving relatively the to-be-scanned picture. A motor, such as a stepping motor, in the scanning apparatus controls the movement of the chassis. The moving distance of the chassis is determined according to the step number of encoder pulses generated when the stepping motor moves the chassis. The relationships between the number of encoder pulses and the moving distance of the chassis may be obtained according to FIGS. 5A to 5C. FIG. 5A is a graph showing a relationship between a moving distance of a chassis and a step pulse in an ideal condition. As shown in FIG. 5A, a chassis in a scanning apparatus having a resolution of 600 DPI (Dots Per Inch) is moved by 1/600 inches in an ideal step when a step pulse is generated. If no transmission error is caused, the chassis is moved by 8/600 inches precisely after 8 step pulses are generated.

When the mechanism has variations, the moving distance of the chassis is not equal to 1/600 inches when the motor generates one step pulse. FIG. 5B is a graph showing a relationship between the moving distance of the chassis and the step pulse when the moving distance of the chassis is shortened. As shown in FIG. 5B, when 8 step pulses are generated, the chassis is not moved by 8/600 inches precisely, and its moving distance is only about 5.3/600 inches. However, the scanning apparatus still regards that the chassis has been moved by 8/600 inches. FIG. 5C is a graph showing a relationship between the moving distance of the chassis and the step pulse when the moving distance of the chassis is lengthened. As shown in FIG. 5C, the chassis is not moved by 8/600 inches precisely after 8 step pulses of the pulse signal P are generated, and the moving distance of the chassis is about 10.7/600 inches. However, the scanning apparatus still regards that the chassis is moved by 8/600 inches.

In summary, the scanning apparatus misjudges the moving distance of the chassis under the conditions of FIGS. 5B and 5C. Thus, the scanned image under the condition of FIG. 5B is enlarged on the vertical axis, and the scanned image under the condition of FIG. 5C is reduced on the vertical axis. Both of the conditions may cause errors of finding the leading edge of the document, of the image magnification in the scanning direction, and of the parameters such as the color registration. Thus, the scanned image quality is deteriorated and is quite different from that of the to-be-scanned picture.

### SUMMARY OF THE INVENTION

It is therefore an object of the invention to provide a method of adjusting an image parameter and a scanning apparatus using the method.

The invention achieves the above-identified object by providing a method of adjusting an image parameter. The method includes the steps of: scanning a standard picture and moving the standard picture by an actual distance; generating a pulse signal corresponding to the actual distance; getting a standard distance corresponding to the pulse signal; and comparing the actual distance with the standard distance and adjusting a default pulse frequency. The default pulse frequency is increased when the actual distance is shorter than the standard distance, and decreased when the actual distance is longer than the standard distance.

The invention also achieves the above-identified object by providing a scanning apparatus including a chassis, a motor and a processor. The chassis scans a standard picture to generate an image signal. The motor moves at least one of the chassis and the standard picture relative to each other by an actual distance. The motor has an encoder for generating a pulse signal when the motor operates to move the chassis or the standard picture relative to each other by the actual distance. The processor receives the pulse signal and the image signal, computes the actual distance according to the image signal, compares the actual distance with a standard distance corresponding to the pulse signal, and adjusts a default pulse frequency. The default pulse frequency is increased when the actual distance is shorter than the standard distance, and decreased when the actual distance is longer than the standard distance.

Other objects, features, and advantages of the invention will become apparent from the following detailed description of the preferred but non-limiting embodiment. The following description is made with reference to the accompanying drawings.

### BRIEF DESCRIPTION OF THE DRAWINGS

FIG. 1 is a schematic illustration showing a scanning apparatus according to a preferred embodiment of the invention.

FIG. 2 is a flow chart showing a method of adjusting an image parameter according to the preferred embodiment of the invention.

FIG. 3 is a schematic illustration showing a standard picture, which is a to-be-scanned document.

FIG. 4 is a schematic illustration showing a standard picture fixed in the scanning apparatus.

FIG. 5A is a graph showing a relationship between a moving distance of a chassis and a step pulse in an ideal condition.

FIG. 5B is a graph showing a relationship between the moving distance of the chassis and the step pulse when the moving distance of the chassis is shortened.

FIG. 5C is a graph showing a relationship between the moving distance of the chassis and the step pulse when the moving distance of the chassis is lengthened.

FIG. 6A is a schematic illustration showing a result obtained after the scanning apparatus scans the standard picture when the actual distance is equal to the standard distance.

FIG. 6B is a schematic illustration showing a result obtained after the scanning apparatus scans the standard picture when the actual distance is longer than the standard distance.

FIG. 6C is a schematic illustration showing a result obtained after the scanning apparatus scans the standard picture when the actual distance is shorter than the standard distance.

### DETAILED DESCRIPTION OF THE INVENTION

FIG. 1 is a schematic illustration showing a scanning apparatus according to a preferred embodiment of the invention. The scanning apparatus 100 includes a chassis 110, a motor 120 and a processor 150. The chassis 110 includes optical and electric elements, such as a light source, reflecting mirrors, a lens and a charge coupled device (CCD), to acquire an image of a to-be-scanned picture.

The motor 120 is, for example, a DC motor for producing a relative displacement between the chassis 110 and the to-be-scanned picture. The motor 120 has an encoder 140 and a code wheel 130. When the motor 120 moves the chassis 110 relative to the to-be-scanned picture or moves the to-be-scanned picture relative to the chassis 110, the code wheel 130 is also rotated. The encoder 140 obtains a rotation state of the motor 120 according to a rotation state of the code wheel 130. The encoder 140 generates a pulse signal P according to the rotation of the motor 120.

The processor 150 obtains a forwarding distance of the chassis 110 relative to the to-be-scanned picture according to a pulse signal P and a default pulse frequency (default pulse per DPI), and thus determines the image parameters of the to-be-scanned picture, such as a leading edge of a document, an image magnification in the scanning direction, a color registration, and/or the like. The pulse signal P is the number of encoder pulses outputted by the encoder 140 when a relative movement between the chassis 110 and the to-be-scanned picture is produced. The default pulse is frequency is a default value, which defines the number of encoder pulses outputted by the encoder 140 when the relative movement between the chassis 110 and the to-be-scanned picture equals a distance between two adjacent scan lines.

When an image parameter adjusting procedure is performed, the chassis 110 scans a standard picture to generate a corresponding image signal, and the motor 120 moves the chassis 110 and the standard picture to produce an actual distance between the chassis 110 and the standard picture. The encoder 140 generates the pulse signal P according to the rotation of the motor 120 corresponding to the actual distance. The processor 150 calculates the actual distance according to the image signal, which is acquired by the chassis 110 and corresponds to the standard picture, and compares the actual distance with the standard distance corresponding to the pulse signal P so as to adjust the default pulse frequency. When the actual distance is shorter than the standard distance, the processor 150 increases the default pulse frequency. When the actual distance is longer than the standard distance, the processor 150 decreases the default pulse frequency.

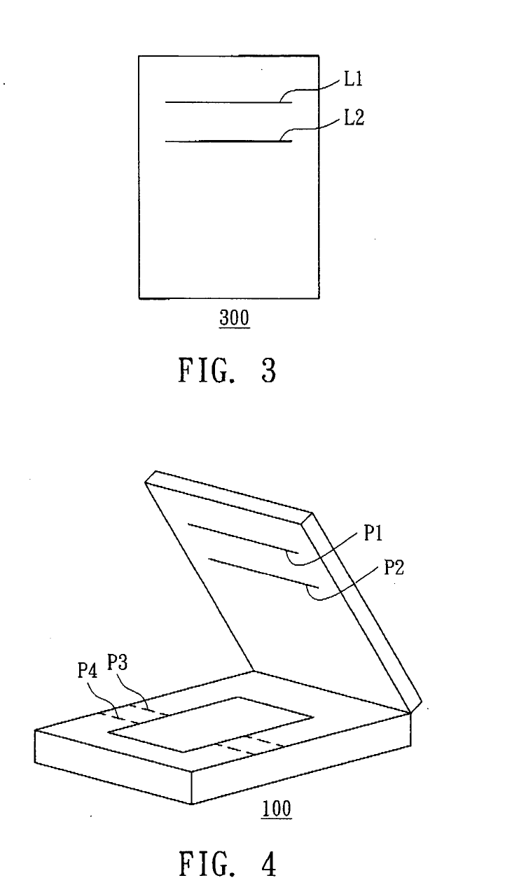

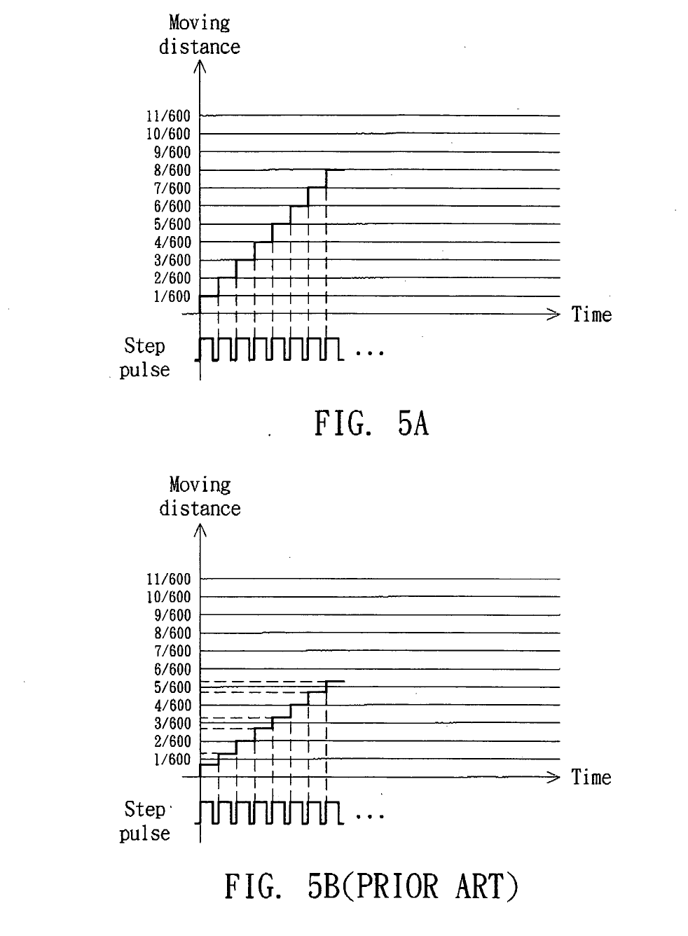

The standard picture has multiple straight lines or calibration lines, and the actual distance is obtained according to a gap between the straight lines or the calibration lines. The standard picture may be implemented in two ways. In the first way, the standard picture is a to-be-scanned document. In the second way, the standard picture is fixed in the scanning apparatus 100. FIG. 3 is a schematic illustration showing a standard picture, which is a to-be-scanned document. The standard picture 300 is a to-be-scanned document having a plurality of straight lines, such as straight lines L1 and L2. The actual distance is the distance between the straight lines L1 and L2. FIG. 4 is a schematic illustration showing a standard picture fixed in the scanning apparatus 100. As shown in FIG. 4, the standard picture is directly scanned by the scanning apparatus 100 without a scanning document. The scanning apparatus 100 gets the actual distance according to the gap between the calibration lines P1 and P2, or between the calibration lines P3 and P4.

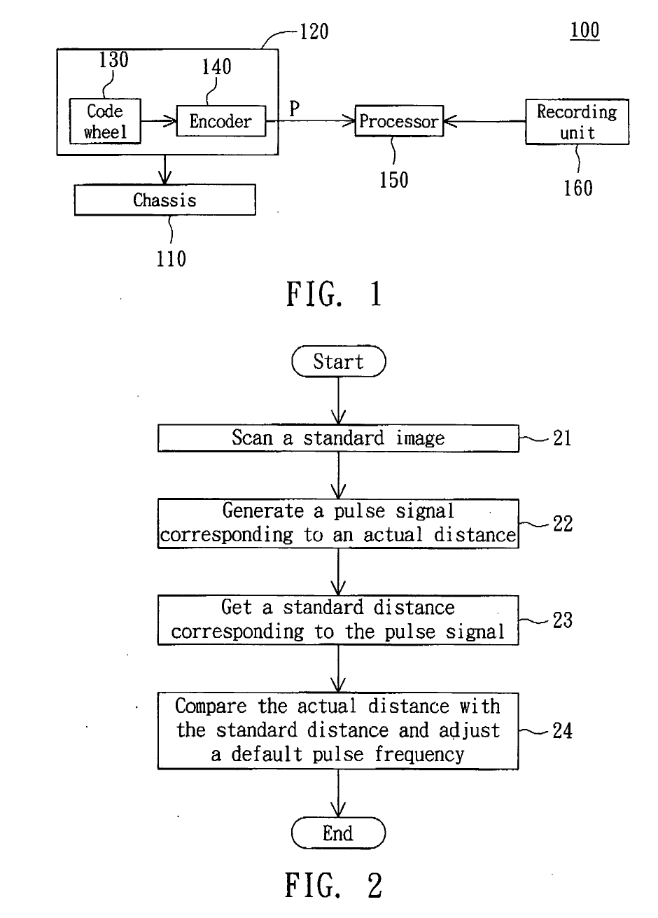

FIG. 2 is a flow chart showing a method of adjusting an image parameter according to the preferred embodiment of the invention. First, the chassis 110 scans the standard picture and the standard picture is moved the actual distance relatively, as shown in step 21. Next, the encoder 140 generates the pulse signal P corresponding to the actual distance, as shown in step 22. Then, the processor 150 gets the standard distance corresponding to the pulse signal P, as shown in step 23. Finally, the processor 150 compares the actual distance with the standard distance and adjusts the default pulse frequency, as shown in step 24.

In step 23, the standard distance is obtained by calculation according to the default pulse frequency and the pulse signal P. Alternatively, the scanning apparatus 100 may further include a recording unit 160, and the processor 150 may get the standard distance from the recording unit 160. In step 24, when the actual distance is shorter than the standard distance, the processor 150 increases the default pulse frequency. When the actual distance is longer than the standard distance, the processor 150 decreases the default pulse frequency.

For example, in a scanning apparatus having the optical resolution of 600 DPI, it is assumed that the standard distance corresponding to the pulse signal P is 1/600 inches when 128 pulses are generated in the pulse signal P, and the default pulse frequency is 128 pulses. Because of the uncertain variation factors in the mechanism, the actual distance between the chassis and the standard picture may be smaller than or greater than 1/600 inches when 128 pulses are generated in the pulse signal P. As shown in step 24, if the actual distance is greater than 1/600 inches, the units of the 128 pulses are reduced or the default pulse frequency is reduced. If the actual distance is smaller than 1/600 inches, the units of the 128 pulses are enlarged or the default pulse frequency is increased.

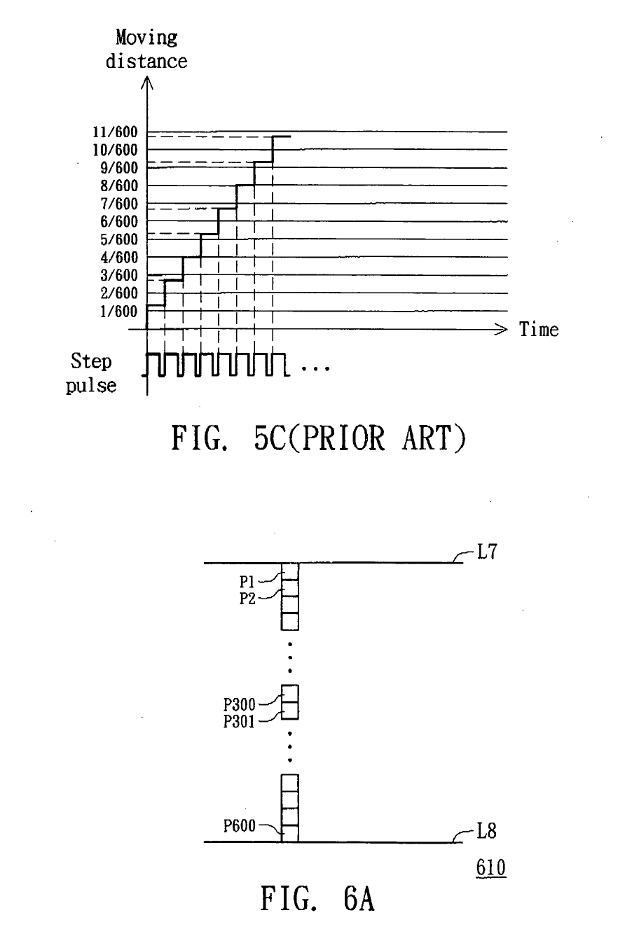

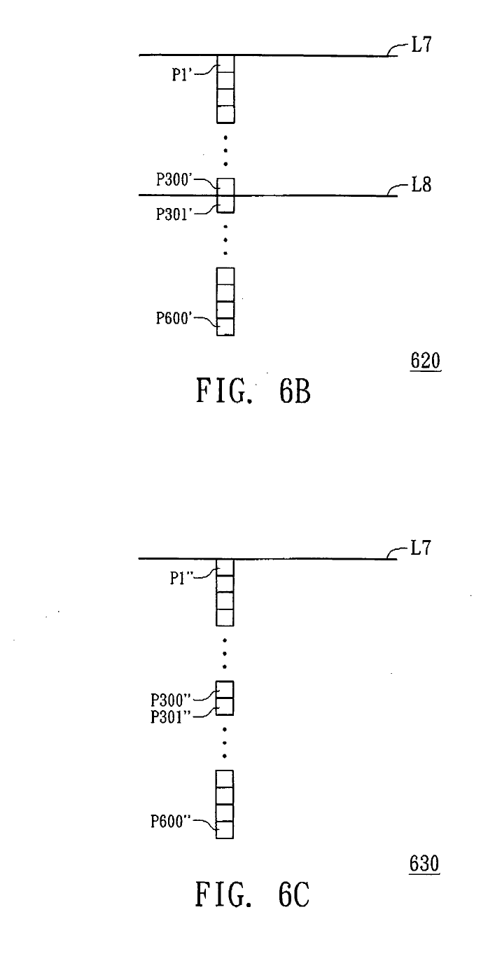

The distortion state on the vertical axis of the scanned image will be described below. With reference to the scanning apparatus 100 having the resolution of 600 DPI, wherein the default pulse frequency is 128 pulses per DPI. When the encoder 140 generates a pulse signal P having 128 pulses, it means that the forwarding pixel distance of the chassis 110 is 1/600 inches, and the processor 150 calculates the forwarding distance of the chassis and the associated image parameters according to the pulse signal P. FIG. 6A is a schematic illustration showing a result obtained after the scanning apparatus scans the standard picture 300 of FIG. 3. The straight line L7 in an image 610 of the standard picture corresponds to the straight line L1, and the straight line L8 corresponds to the straight line L2. The distance between the straight line L1 and the straight line L2 is 1 inch. In an ideal condition when no error is caused in the transmission of the gear set, the gap between the straight line L7 and the straight line L8 is defined by pixels P1 to P600, each of which represents 1/600 inches in the standard picture 300.

FIG. 6B is a schematic illustration showing a result obtained after the scanning apparatus scans the standard picture when the actual distance is longer than the standard distance. In this case, the gear transmission error enlarges the moving distance of the chassis 110. For example, the chassis 110 can acquire the straight lines L7 and L8 when it is moved by the distance of 300 pixels. That is, the actual moving distance of the chassis 110 is 1/300 inches every 128 pulses. Thus, it is observed that only 300 pixels P1′ to P300′ exist between the straight lines L7 and L8 rather than the original 600 pixels, as shown in FIG. 6B, and the image corresponding to pixels P301′ to P600′ is additionally acquired. When the encoder 140 generates 128 pulses, the moving distance of the chassis is no longer 1/600 inches. Thus, the default pulse frequency (or Default Pulse per DPI, DPD) has to be reduced to obtain a corrected pulse frequency (or Corrected Pulse per DPI, CPD) as:
CPD=(300/600)*128=64 (1)

FIG. 6C is a schematic illustration showing a result obtained after the scanning apparatus scans the standard picture when the actual distance is shorter than the standard distance. In this case, the actual moving distance per pixel unit of the chassis 110 is shortened. For example, if the chassis 110 can acquire the image of straight lines L1 and L2 as it is moved by the distance of 600 pixels in the ideal state, then the chassis 110 has to be moved by the distance of 1200 pixels such that the straight lines L1 and L2 may be acquired. That is, the moving distance of the chassis 110 is 1/1200 inches after 128 pulses are generated. In the ideal state, 600 pixels should exist between the straight lines L7 and L8. In FIG. 6C, however, pixels P1″ to P600″ cannot be extended from the straight line L8 to the straight lines L8. Because the pixels P1″ to P600″ only correspond to one half of the original image ranging from the straight line L1 to the straight line L2. The default pulse frequency (DPD) should be increased as:
CPD=(1200/600)*128=256 (2).

According to Equations (1) and (2), it is obtained that:
CP2D=(P/T)*DPD (3),
wherein T is the theoretical number of pixels per unit distance, 600 pixels represent 1 inch in this embodiment, and P is the practical number of pixels per unit distance. In the example of FIG. 6B, P is 300. In the example of FIG. 6C, P is 1200.

In order to simplify the system design, the values of DPD and CPD are integers without fractions. In other words, the minimum difference |ΔP| between DPD and CPD before or after been adjusted has to be “1”. So, the precision compensating limit (the difference |ΔP|) of this adjusting principle may be calculated according to Equation (3) as:
|CPD−DPD|≧1.

Substitute CPD=(P/T)*DPD into the former equation, it is obtained that:
|(P/T)*DPD−DPD|≧1.

Remove the signs for absolute value, it is obtained that:
(P/T)*DPD−DPD≧1 (4)
or
(P/T)*DPD−DPD≦−1 (5).

It is obtained, from Equation (4), that:
P*DPD−T*DPD≧T, and
P≧(DPD+1)*T/DPD (6).

It is obtained, from Equation (5), that:
P*DPD−T*DPD)≦T, and
P≦(DPD+1)*T/DPD (7).

It is obtained, from Equations (6) and (7), that:
|ΔP|≧{[(DPD+1)/DPD]*T−T}/T*100%, and
|ΔP|≧(100/DPD)*100% (8).

Calculating the difference |ΔP| according to Equation (8) means that the adjustment may be made according to Equation (3) as long as the position error caused by the gear set when the chassis or the sheet is moved is greater that the difference |ΔP|.

The methods of performing the image parameter adjusting procedure in the scanning apparatus 100 will be described in the following. In a first method, the scanning apparatus 100 may include a user interface (not shown), and the user can enable the image parameter adjusting procedure through the user interface, such as an adjust-enable button (not shown) of the scanning apparatus 100, or through a computer host electrically connected to the scanning apparatus 100. In the second method, the recording unit 160 also records the usage state of the scanning apparatus 100, and the processor 150 automatically enables the image parameter adjusting procedure according to the usage state of the scanning apparatus 100.

The method of adjusting image parameters and the scanning apparatus according to the embodiment of the invention can adjust the errors of the mechanical parameters, which are caused by the deteriorated transmission precision and are neglected in the conventional adjusting method. The method may further analyze the associated parameters and adjust the associated compensation parameters, such that the associated parameters are free from being influenced by the variation of the transmission precision, and the image quality may be ensured. The invention can be applied to a production line to finely adjust the scanning apparatuses before they are shipped out. After the scanning apparatus has been used for a period of time at the user end, the user can make the adjustment or the scanning apparatus can make the adjustment automatically so as to keep the scan magnification on the desired precision level after a long term of usage.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of adjusting an image parameter in a scanning apparatus, the method comprising the steps of:
scanning a standard picture and moving the standard picture by an actual distance;
generating a pulse signal corresponding to the actual distance;
getting a standard distance corresponding to the pulse signal; and
comparing the actual distance with the standard distance and adjusting a default pulse frequency,
wherein the default pulse frequency is increased when the actual distance is shorter than the standard distance, and decreased when the actual distance is longer than the standard distance.

2. The method according to claim 1, wherein the standard picture has a plurality of straight lines or calibration lines, and the actual distance is got according to a gap between the straight lines or the calibration lines.

3. The method according to claim 1, wherein the standard picture is a to-be-scanned document.

4. The method according to claim 1, wherein the standard picture is fixed in the scanning apparatus.

5. The method according to claim 1, wherein the standard distance is stored in a recording unit of the scanning apparatus.

6. The method according to claim 1, wherein the standard distance is got by computation according to the default pulse frequency and the pulse signal.

7. The method according to claim 1, wherein the motor is a DC (Direct Current) motor.

8. A scanning apparatus capable of performing an image parameter adjusting procedure, the scanning apparatus comprising:
a chassis for scanning a standard picture to generate an image signal;
a motor for moving at least one of the chassis and the standard picture relative to each other by an actual distance, wherein the motor has an encoder for generating a pulse signal when the motor operates to move the chassis or the standard picture relative to each other by the actual distance; and
a processor for receiving the pulse signal and the image signal, computing the actual distance according to the image signal, comparing the actual distance with a standard distance corresponding to the pulse signal, and adjusting a default pulse frequency,
wherein the default pulse frequency is increased when the actual distance is shorter than the standard distance, and decreased when the actual distance is longer than the standard distance.

9. The apparatus according to claim 8, further comprising a recording unit for recording a usage state of the scanning apparatus.

10. The apparatus according to claim 9, wherein the processor enables the image parameter adjusting procedure according to the usage state.

11. The apparatus according to claim 8, further comprising a user interface, through which a user enables the image parameter adjusting procedure.

12. The apparatus according to claim 8, wherein the standard picture has a plurality of straight lines or calibration lines, and the processor gets the actual distance according a gap between the straight lines or the calibration lines.

13. The apparatus according to claim 8, wherein the standard picture is a to-be-scanned document.

14. The apparatus according to claim 8, wherein the standard picture is fixed in the scanning apparatus.

15. The apparatus according to claim 8, further comprising a recording unit for storing the standard distance.

16. The apparatus according to claim 8, wherein the processor gets the standard distance by computation according to the default pulse frequency and the pulse signal.

17. The apparatus according to claim 8, wherein the motor is a DC (Direct Current) motor.
